(19) United States
(12) Patent Application Publication
(10) Pub. No.: US 2019/0110465 A1
(43) Pub. Date: Apr. 18, 2019

(54) Scent slinger

(71) Applicant: Nathan Turrel Latimer, Clarkston, MI (US)

(72) Inventor: Nathan Turrel Latimer, Clarkston, MI (US)

(21) Appl. No.: 16/350,095

(22) Filed: Sep. 24, 2018

Related U.S. Application Data
(60) Provisional application No. 62/606,937, filed on Oct. 13, 2017.

(51) Int. Cl. A01M 31/00; F42B 12/36

(52) U.S. Cl. CPC A01M 31/008; F41B 3/02; F42B 12/36

(57) ABSTRACT

A projectile to be fired from a slingshot. The projectile includes a pellet, a sheet adsorbent material and an adhesive. The sheet of adsorbent material is wrapped around the pellet so that a portion of the adsorbent material is exposed. The adhesive is positioned on a portion of the adsorbent material. A liquid scent is applied to the sheet of adsorbent material before or after the projectile is placed in the pouch of a slingshot so that the projectile can be launched from the slingshot to disperse the scent to location remote from the slingshot.

### BACKGROUND OF THE INVENTION

The instant invention relates to the field of hunting aids and more specifically to application of animal scent to a hunting area. As discussed in U.S. Pat. No. 5,303,496, it is common for hunters to use deer musk, bear musk, or other scents as an attractant for animals being hunted. The scents attract the animals to an area where a hunter waits. Hunters usually purchase these scents as liquids in bottles, and then apply the scent to a location where they are planning to hunt. The biggest problem with this method of scent application is that a hunter leaves human scent at the same location. Since animals can be repelled by human scent, this type of application lessen the effectiveness of the attractant scent. In addition, such attractant scents are very strong, and objectionable to human smell. Currently, the most common method of application for these scents is by physically going to the location to be hunted and applying the scent manually to rocks, trees, or shrubs in the hunting area. Alternatively, the scents may be dispersed from spray bottles. In those methods of scent application, the hunter is subjected to the objectionable smell of the attractant scents, in addition to contaminating the hunting area with human scent. The above-referenced U.S. Pat. No. 5,303,496 provides a solution the above-mentioned problems by placing a scent in a breakable capsule that is then fired by the hunter to a location remote from the hunter so that when the capsule lands the capsule can break open and disperse the scent. The system provided by U.S. Pat. No. 5,303,496 requires that the capsule land on a hard surface so that the capsule can break open and disperse the scent. There remains a need for a system to project a scent that overcomes this and other problems.

### SUMMARY OF THE INVENTION

The instant invention is the discovery of a new and unobvious system to, among other things, project a scent. The system of the instant invention overcomes problems encountered with prior art systems. More specifically, the instant invention in one embodiment is a projectile to be fired from a slingshot, the projectile comprising a pellet, a sheet adsorbent material and an adhesive, the sheet of adsorbent material wrapped around the pellet so that a portion of the adsorbent material is exposed, the adhesive positioned on the portion of the adsorbent material that is exposed. In another embodiment, the instant invention is a method for projecting a scent from one location to another location, comprising: (a) positioning a projectile of the instant invention into the pouch of a slingshot; (b) depositing a liquid scent onto the adsorbent material of the projectile before or after positioning the projectile into the pouch of the slingshot; and (c) firing the projectile from the slingshot to a location remote from the slingshot. In another embodiment, the instant invention is a method for dispersing scent from a tree, comprising: (a) attaching an adhesive material to a tree; (b) attaching a projectile of the instant invention to the adhesive material attached to the tree, the adhesive material of the projectile being compatible with the adhesive material attached to the tree; (c) depositing a liquid scent onto the adsorbent material of the projectile before or after attaching the projectile to the adhesive material attached to the tree so that the liquid scent evaporates to disperse scent from the tree.

### BRIEF DESCRIPTION OF THE DRAWINGS

FIG. 1 shows a highly preferred slingshot and projectile of the instant invention with the projectile attached to the pouch of the slingshot by a hook and loop adhesive system;

FIG. 2 shows the embodiment shown in FIG. 1 with the projectile separated from the pouch and with the eyedropper of the handle removed;

FIG. 3 shows the pouch of the slingshot of FIG. 1 detailing the hook and loop adhesive attached to the pouch;

FIG. 4 shows the projectile of FIG. 1 detailing the hook and loop adhesive attached to the exposed portion of a woven patch wrapped on a slingshot pellet; and

FIG. 5 shows the projectile of FIG. 1 attached to a tree branch by a hook and loop adhesive system.

### DETAILED DESCRIPTION OF THE INVENTION

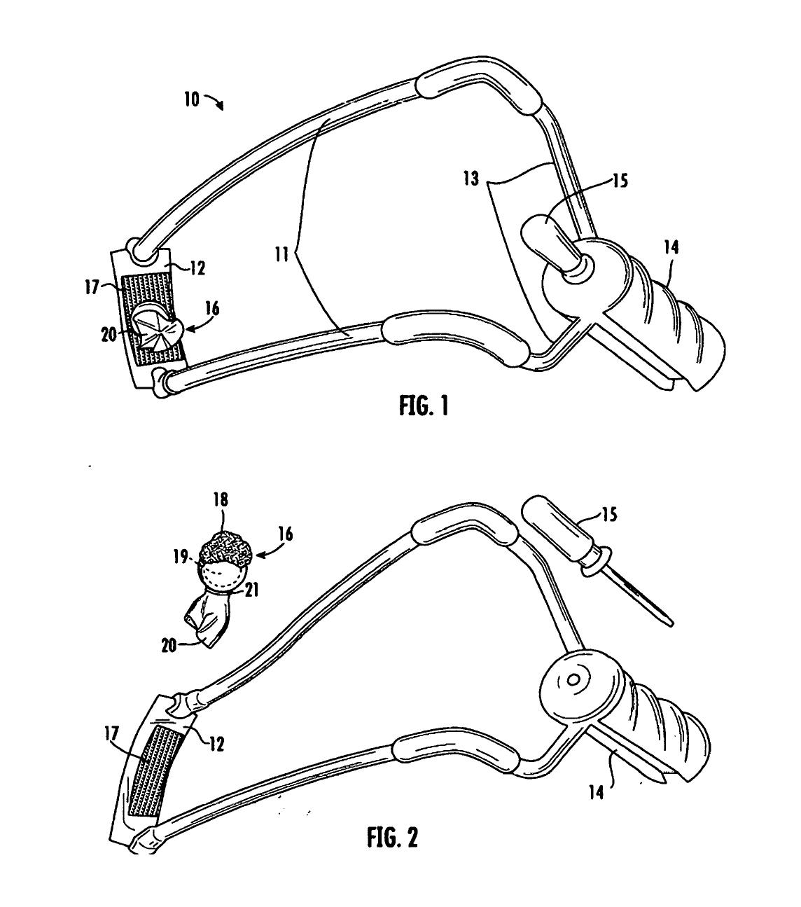

Referring now to FIG. 1, therein is shown a highly preferred slingshot 10 and projectile 16 of the instant invention. Slingshot 10 is comprised of handle 14, arms 13, rubber tubing 11 and projectile pouch 12. Handle 14 comprises a container for holding liquid scent. Eyedropper 15 is shown inserted into handle 14. Referring now to FIG. 2, therein is shown the embodiment shown in FIG. 1 with projectile 16 separated from pouch 12 and with eyedropper 15 removed from handle 14.

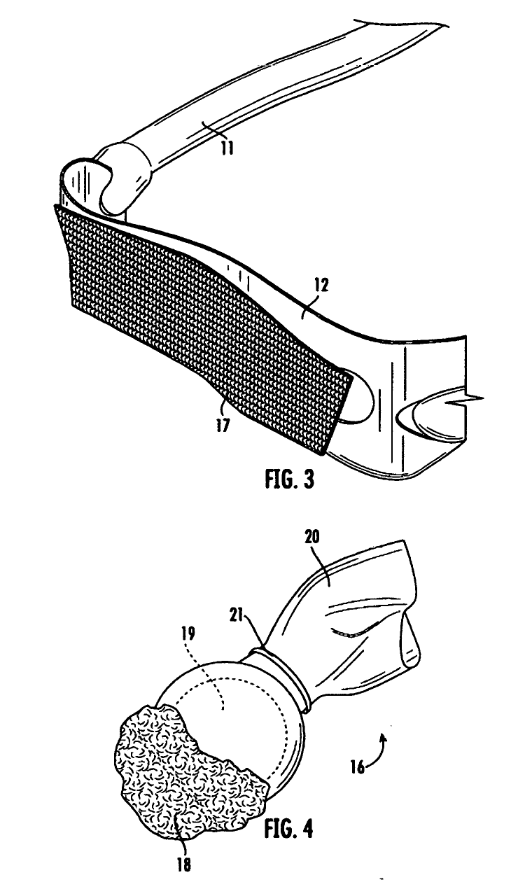

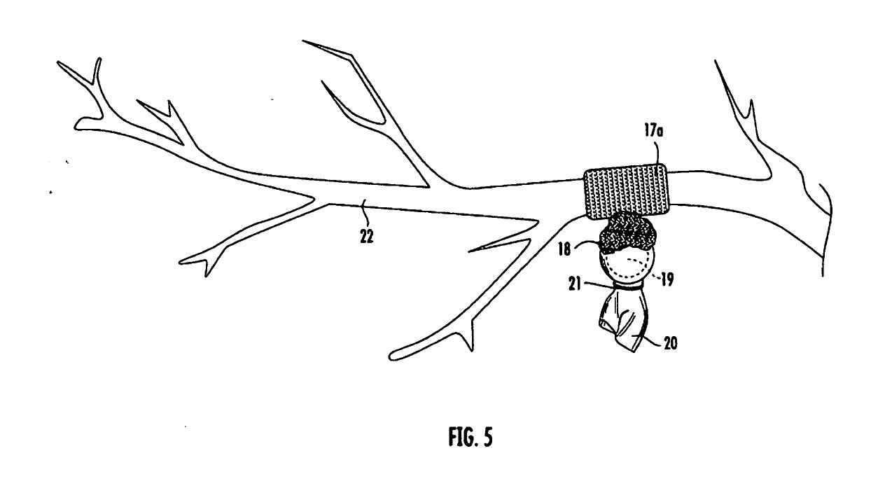

Referring now to FIG. 3, therein is shown a detailed drawing of pouch 12 of the slingshot of FIG. 1 detailing the hook and loop adhesive 17 attached to pouch 12. Referring now to FIG. 4, therein is shown a detailed drawing of projectile 16 of FIG. 1 detailing hook and loop adhesive 18 attached to the exposed portion of absorbent woven patch 20 wrapped on slingshot pellet 19 and held in place by tie 21. Hook and loop adhesive 18 is compatible with hook and loop adhesive 17 shown in FIG. 3 so that when projectile 16 is placed in pouch 12, projectile 16 is held on pouch 12 so that liquid scent can be deposited on patch 20 by a hunter without getting said scent on the hunter.

The hunter can then fire the scented projectile to a location remote from hunter. It should be understood that a slingshot comprising the container for holding liquid scent is optional and in some cases it will be preferred to apply liquid scent to patch 20 before projectile 16 is placed in the pouch of a slingshot.

The components of the instant invention can be made of any suitable material. For example, VELCRO brand hook and loop adhesive is preferred in the instant invention as described above in reference, for example, to elements 17 and 18 of FIG. 2, any suitable adhesive system can be used as long as the adhesive on the pouch of the slingshot is compatible with the adhesive on the projectile. For example, a pressure sensitive adhesive can be used both on the projectile and the pouch of the slingshot. A slingshot handle comprising a container for the scent is optional in the instant invention. Any slingshot pellet is preferred in the projectile of the instant invention and can comprise without limitation thereto, pellets made of plastic, glass, wood or metal.

When an adhesive (such as a hook and loop adhesive component) is attached to a hunting blind or to an object at a hunting location such as a tree, a projectile of the instant invention can be attached to said adhesive so that a cover scent can be deposited on the projectile to provide a cover scent for the hunting location. For example, FIG. 5 shows a strip of VELCRO brand two sided hook and loop adhesive 17a wrapped around tree branch 22 so that a projectile of the instant invention can be attached to adhesive 17a by compatible VELCRO brand hook and loop adhesive 18. When used to provide a cover scent the color of the patch 20 is not critical in the instant invention. When launched from a slingshot, it is preferred that patch 20 be red or orange in color to facilitate recovery and reuse of the projectile. Referring again to FIG. 5, liquid scent can be deposited on patch 20 before or after the projectile is attached to the tree or to a hunting blind or other such location. In another application, a scented projectile of the instant can be dragged on the ground by a string or other such line attached to the projectile to provide a scent trail. In yet another application, a scented projectile of the instant invention can be attached to a three dimensional decoy (such as a doe in heat scented projectile of the instant invention attached to a 3D doe decoy). Thus, it should be understood that while the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A projectile to be fired from a slingshot, the projectile comprising: a pellet, a sheet adsorbent material and an adhesive, the sheet of adsorbent material wrapped around the pellet so that a portion of the adsorbent material is exposed, the adhesive positioned on the portion of the adsorbent material that is exposed.

2. The projectile of claim 1, wherein the pellet is a plastic slingshot pellet, the sheet of adsorbent material is a patch of woven material and the adhesive comprises a hook and loop adhesive.

3. The projectile of claim 1 and a slingshot, the slingshot comprising a handle, a forked support attached to the handle, elastic members attached at one end thereof to each arm of the forked support and at the other end thereof to a pouch, the pouch comprising an adhesive compatible with the adhesive of the projectile of claim 1 so that the projectile of claim 1 will be retained in the pouch by the adhesive of the pouch in cooperation with the adhesive of the projectile so that liquid scent can be deposited onto the sheet of adsorbent material so that the projectile can be fired from the slingshot to a location remote from the slingshot.

4. The projectile of claim 2 and a slingshot, the slingshot comprising a handle, a forked support attached to the handle, elastic members attached at one end thereof to each arm of the forked support and at the other end thereof to a pouch, the pouch comprising a hook and loop adhesive compatible with the hook and loop adhesive of the projectile of claim 2 so that the projectile of claim 2 will be retained in the pouch by the adhesive of the pouch in cooperation with the adhesive of the projectile so that liquid scent can be deposited onto the sheet of adsorbent material so that the projectile can be fired from the slingshot to a location remote from the slingshot.

5. A method for projecting a scent from one location to another location using the projectile and slingshot of claim 3, comprising: (a) positioning a projectile of claim 3 into the pouch of the slingshot of claim 3; (b) depositing a liquid scent onto the adsorbent material before or after positioning the projectile of claim 3 into the pouch of the slingshot of claim 3; and (c) firing the projectile of claim 3 from the slingshot of claim 3 to a location remote from the location of the slingshot of claim 3.

6. A method for dispersing scent from a tree, comprising: (a) attaching an adhesive material to a tree; (b) attaching a projectile of claim 1 to the adhesive material attached to the tree, the adhesive material of the projectile of claim 1 being compatible with the adhesive material attached to the tree; (c) depositing a liquid scent onto the adsorbent material of the projectile of claim 1 before or after attaching the projectile of claim 1 to the adhesive material attached to the tree so that the liquid scent evaporates to disperse scent from the tree.
